(19) United States
(12) Patent Application Publication
(10) Pub. No.: US 2025/0308871 A1
(43) Pub. Date: Oct. 2, 2025

(54) SYSTEMS AND METHODS FOR AUTOMATIC SAMPLE RE-RUNS IN SAMPLE ANALYSYS

(71) Applicant: DH Technologies Development Pte. Ltd., Singapore (SG)

(72) Inventors: Chiu Cheong AW, Singapore (SG); Han WANG, Singapore (SG); Chang LIU, Richmond Hill (CA); Thomas R. Covey, Newmark (CA)

(73) Assignee: DH Technologies Development Pte. Ltd., Singapore (SG)

(21) Appl. No.: 18/864,298

(22) PCT Filed: May 8, 2023
(86) PCT No.: PCT/IB2023/054770

§ 371 Date: Nov. 8, 2024

Related U.S. Application Data
(60) Provisional application No. 63/340,202, filed on May 10, 2022.

(51) Int. Cl. H01J 49/00; H01J 49/04

(52) U.S. Cl. CPC H01J 49/0036; H01J 49/0418; H01J 49/0454

(57) ABSTRACT

A method and system for correcting a measurement in a sample analyzing system, the method including receiving a first sample at an interface of the sample analyzing system, the first sample being a portion of a sample source; measuring a first signal for the received first sample to generate a measured first signal; comparing the measured first signal to an expected characteristic of the sample analyzing system to determine whether the measured first signal is valid; and when the measured first signal is determined not to be valid: taking one or more corrective actions on one of the sample analyzer and the sample source; receiving a second sample at the sampling interface, the second sample being another portion of the sample source; and measuring a second signal for the received other sample to generate a measured second signal.

### CROSS-REFERENCE TO RELATED APPLICATIONS

This application is being filed on May 8, 2023, as a PCT International Patent Application that claims priority to and the benefit of U.S. Provisional Application No. 63/340,202, filed on May 10, 2022, the disclosure of which is hereby incorporated by reference in its entirety.

### BACKGROUND

Acoustic Ejection Mass Spectrometry (AEMS) is a high-throughput analytical platform, where nano-liter sized droplets, or samples, are ejected acoustically from a sample well plate in a non-contact manner, and captured in an open port interface (OPI). The sample is diluted and transferred from the OPI to a mass spectrometer (MS) for analysis. Each ejection typically generates a one-second baseline wide peak on the standard system setup, which determines the analytical throughput to one well every second, or ˜1 Hz.

### SUMMARY

In one aspect, the technology relates to method of correcting a measurement in a sample analyzing system, the method including receiving a first sample at an interface of the sample analyzing system, the first sample being a portion of a sample source; measuring a first signal for the received first sample to generate a measured first signal; comparing the measured first signal to an expected characteristic of the sample analyzing system to determine whether the measured first signal is valid; and when the measured first signal is determined not to be valid: one of taking no corrective action and taking one or more corrective actions on one of the sample analyzer and the sample source; receiving a second sample at the sampling interface, the second sample being another portion of the sample source; and measuring a second signal for the received other sample to generate a measured second signal.

In an example of the above aspect, correcting the measurement in the sample analyzing system includes correcting the measurement in at least one of an acoustic ejector, an ionization chamber and a mass spectrometer. In another example, receiving the first sample at the interface of the sample analyzing system includes receiving the first sample at a sampling open port interface. In yet another example, receiving the first sample at the interface of the sample analyzing system includes receiving the first sample at one of a matrix-assisted laser desorption interface and a pneumatic nebulizer interface. In another example, measuring the first signal for the received first sample includes measuring a signal indicative of a number of detected ions per second; measuring a signal peak corresponding to the received first sample; measuring an acoustic ejection energy of the received first sample; and/or measuring at least one of a height of the signal peak, an area under the peak of the signal peak, and a full-width-half maximum of the signal peak.

In another example of the above aspect, comparing the measured first signal to the expected characteristic of the sample analyzing system includes comparing the measured first signal to at least one of a predetermined signal intensity threshold, a predetermined signal intensity range, a predetermined acoustic ejection energy threshold, and a predetermined mass. In yet another example, the signal is determined to be invalid when at least one of the signal is under the predetermined signal intensity threshold, the signal is outside of the predetermined signal intensity range, and an acoustic ejection energy of the first sample if below the predetermined acoustic ejection energy threshold. In an example, the predetermined signal intensity range is between 10% and 20% of the measured first signal.

In yet another example of the above aspect, taking the one or more corrective actions includes modifying an operating parameter of at least one of the sample source and the sample analyzing system. In another example, modifying the operating parameter of at least one of the sample source and the sample analyzing system includes modifying at least one of a volume of the sample source to generate the volume of the second sample; a viscosity of the sample in the sample source to generate the viscosity of the second sample; and an acoustic ejection energy for ejecting the second sample. In other examples, receiving the first sample at the sampling interface includes ejecting the first sample from a well plate, the well plate including a plurality of wells, the sample source being contained in one of the plurality of wells, wherein an ejection energy of the first sample comprises an acoustic ejection energy. In an example, the acoustic ejection energy is obtained from an acoustic ejection energy log. In yet another example, measuring the second signal includes automatically measuring the second signal when the first signal is outside of the predetermined range.

In another aspect, the technology relates to a sample analyzing system that includes a sample receiver; a mass analysis device fluidically coupled to the sample receiver; a processor operatively coupled to the sample receiver and to the mass analysis device; and a memory coupled to the processor, the memory storing instructions that, when executed by the processor, perform a set of operations. In one aspect, the set of operations include receiving a first sample at the sample receiver, the first sample being a portion of a sample source; measuring, at the mass analysis device, a first signal for the received first sample to generate a measured first signal; comparing the measured first signal to an expected characteristic of the sample analyzing system to determine whether the measured first signal is valid; and when the measured first signal is determined not to be valid: one of taking no corrective action and taking one or more corrective actions on one of the sample analyzer and the sample source; receiving, at the sample receiver, a second sample at the sampling interface, the second sample being another portion of the sample source; and measuring, at the mass analysis device, a second signal for the received other sample to generate a measured second signal.

In another example of the above aspect, the sample analyzing system includes at least one of an acoustic ejector, an ionization chamber, and a mass spectrometer. For example, the sample receiver includes an open port interface. In yet another example, sample analyzing system further includes a well plate including a plurality of wells, each well comprising at least the first sample and the second sample. In other examples, the sample analyzing system further includes a non-contact sample ejector; wherein the set of operations includes receiving the first sample by introducing, with the non-contact sample ejector, the first sample from the well plate into the sample receiver. For example, the non-contact sample ejector includes an acoustic droplet ejector. In another example, the non-contact sample ejector includes at least one of a matrix-assisted laser desorption interface and a pneumatic nebulizer interface.

In other examples of the above aspect, the first signal includes a signal peak corresponding to the received first sample; an acoustic ejection energy of the received first sample; at least one of a height of the signal peak, an area under the peak of the signal peak, and a full-width-half maximum of the signal peak or other mass spectra information. In yet another example, the set of operations includes comparing the measured first signal to the expected characteristic of the sample analyzing system by comparing the measured first signal to at least one of a predetermined signal intensity threshold, a predetermined signal intensity range, a predetermined acoustic ejection energy threshold, and a predetermined mass. In another example, the set of operation includes determining that the signal is invalid when at least one of the signal is under the predetermined signal intensity threshold, the signal is outside of the predetermined signal intensity range, and an acoustic ejection energy of the first sample if below the predetermined acoustic ejection energy threshold. For example, the set of operations includes measuring the second signal by automatically measuring the second signal when the first signal is determined to be invalid.

In another example of the above aspect, the sample analyzing system further includes an ionization element, wherein the set of operations further comprises ionizing the received first sample and the received second sample by the ionization element towards the mass analysis device. For example, the mass analysis device includes at least one of a differential mobility spectrometer (DMS), a mass spectrometer (MS), and a DMS/MS. In another example, a frequency of ejection of the first sample and the second sample at the sample receiver is greater than 1 Hz. In yet another example, the well plate includes one of 384 wells and 1536 wells.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2 is a schematic diagram illustrating operation of another particular example system in accordance with various embodiments described herein.

FIG. 3 depicts an example acoustic ejection log, according to various examples of the disclosure.

FIG. 4 depicts an example of determining an abnormal signal based on the acoustic ejection log, according to various examples of the disclosure.

FIG. 5 depicts an example of determining an abnormal signal based on a received signal, according to various examples of the disclosure.

FIG. 6 is a flow chart depicting an example method for sample re-runs, in accordance with various embodiments described herein.

FIG. 7 depicts a block diagram of a computing device.

### DETAILED DESCRIPTION

Aspects of the technology described herein are performed on sample portions ejected from a sample source. For example, the sample portions may be droplets, gels, solids, and the like. As another example, the sample source may be or include a reservoir, a well, a container, and the like, and each sample source may include a plurality of sample portions that are similar or identical to each other. For example, the sample portion is a droplet and the sample source is the well that contains the droplet as well as many other droplets. Herein, the term “sample” may be used interchangeably to describe both a sample contained in a sample source as well as a portion of that sample that is ejected from the sample source. When concepts such as a “first sample of the sample source” and a “second sample of the sample source” are discussed and described herein, the first sample and the second sample may correspond to, e.g., a first droplet and a second droplet contained in the same well or reservoir.

High-throughput sample analysis is typically advantageous to the drug discovery process. Bioanalysis technologies include colorimetric microplate-based readers. Such readers, however, are often constrained by linear dynamic range as well as the need for label attachment schemes which have the propensity to modify equilibrium and kinetic analysis. Mass spectrometry based methods can achieve label- free, universal mass detection of a wide range of analytes with improved sensitivity, selectivity, and specificity. For example, the sample is delivered to the mass spectrometer at a rate of multiple samples per second, but a limiting factor for the throughput may be the fact that some sample measurement may include errors due to a variety of reasons such as, e.g., failure of a component of the analysis system, corrupted samples, air bubbles present in the sample, and the like. One solution to this problem may include re-running the sample measurement, or performing the sample measurement one more time, for the specific samples which measurement includes an error. For example, re-running such samples may be performed automatically when the error is detected. The reasons for such errors in sample measurements are further discussed below.

In applications where large numbers of samples, e.g., human tissue samples, provided from various people, are analyzed, the physical nature of the samples may widely vary from, e.g., patient to patient. For example, the viscosity of a blood sample may widely vary from person to person and may result in wide differences between blood samples. As a result, these differences may lead to failure of some sample ejections because, e.g., the ejection parameters may be set for a type of sample and may result in failed ejection for a different type of sample. In various examples, the parameters of the samples that have suffered failed ejections, or the parameters of the sample analyzing system, may be corrected or calibrated, and the ejections of those samples may be performed anew. For example, correction of a sample may be a dilution of the sample before re-running the measurement by performing an ejection of another sample from the same sample source. In the case of an acoustic ejection system, the sample source may be a well from a well plate that includes a plurality of wells. Other corrective actions may include re-running the sample measurement, e.g., i) by performing another ejection from the same sample source but with a greater acoustic ejection energy, ii) after changing the volume of the sample being ejected, and/or iii) after changing a viscosity level of the sample in the sample source, e.g., by diluting the sample source. Changing the dilution of the sample in the sample source may be achieved by, e.g., adding more water to the sample to dilute the sample. In various examples, sample sources for which abnormal signals have been received may be identified and, e.g., a list of such sample sources may be established. In the case of an acoustic ejection system, wells for which abnormal signals have been received may be identified and, e.g., a list of such wells may be established.

In some examples, various modes of failure of the sample measurements may be identified. For example, some of the samples may be corrupted due to a variety of reasons such as, e.g., bubbles forming in the sample, incorrect parameters of the mass spectrometer, or the like, which may result in an abnormal signal. For example, an abnormal signal may be a signal detected by, e.g., the MS, that falls outside of a predetermined range. An abnormal signal may be, e.g. a signal that is significantly higher or significantly lower than the predetermined range. In this case, a calibration may be performed on various components of the sample analyzing system, and the sample measurement may be repeated. In cases where an abnormal signal is detected from specific sample sources or wells, the analysis may be repeated for these specific sample sources or wells. For example, the sample sources or wells for which an abnormal signal has been detected may be prompted to eject another sample for analysis. In other examples, an abnormal signal may be detected if the signal does not conform to a predetermined internal standard that is substantially consistent within a given tolerance, and that is independent of the type of analytes being analyzed. Alternatively, a transition from background ions (matrix-or carrier-derived) may also be monitored to determine abnormalities by, e.g., monitoring background ion levels which should remain substantially consistent.

In other examples, an abnormal signal may be detected based on the mass spectrometer readout, e.g., via the acoustic feedback signal. For example, if the acoustic ejection energy of the sample is outside of a predetermined threshold range, then one or more parameters of the acoustic ejector, or of the mass spectrometer, may be modified before ejecting another sample from the same sample source or well.

The technologies described herein may be implemented in MS using ADE and the examples depicted herein are described in that context for clarity. The technologies may also be utilized in systems that use matrix-assisted laser desorption interface (MALDI), other mass analysis techniques using a pneumatic nebulizer as a sample provider, and the like.

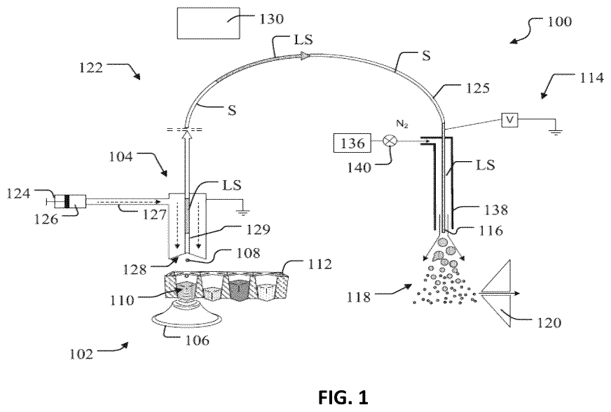

For illustrative purposes, FIG. 1 is a schematic view of an example system 100 combining an acoustic droplet ejection (ADE) 102 with an OPI sampling interface 104 and an ESI source 114, along with a mass spectrometer (MS) 120. Such a system 100 may be referred to as an acoustic ejection mass spectrometry (AEMS) system 100. The AEMS system 100 may include a mass analysis instrument such MS 120 for ionizing and mass analyzing analytes received within an open end of the sampling OPI 104. Such a system 100 is described, for example, in U.S. Pat. No. 10,770,277, the disclosure of which is incorporated by reference herein in its entirety. The ADE 102 includes an acoustic ejector 106 that is configured to eject a droplet or sample 108 from a reservoir 110 of a well plate 112 into the open end of sampling OPI 104. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (e.g., a MS depicted generally at 120) in communication with the ionization chamber 118 for downstream processing and/or detection of ions generated by the ESI source 114. Due to the configuration of the nebulizer nozzle 138 and electrospray electrode 116 of the ESI source 114, samples ejected therefrom are transformed into small-volume liquid droplets flying in a gas. A liquid handling system 122 (e.g., including one or more pumps 124 and one or more transfer conduits 125) provides for the flow of liquid from a reservoir 126 to the sampling OPI 104 and from the sampling OPI 104 to the ESI source 114. As ESI source 114 allows for the formation of multiple charged ions and are, therefore, more applicable to a variety of applications, they are described within the application for consistency. The technologies described herein, however, may also be utilized for systems that incorporate a plurality of atmospheric pressure chemical ionization (APCI) sources.

In FIG. 1, the reservoir 126 (e.g., containing a liquid, desorption solvent, a sample to be tested, etc.) can be fluidically coupled to the OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in greater detail below, the flow of liquid into and out of the sampling OPI 104 occurs within a sample space accessible at the open end such that one or more droplets or samples 108 can be introduced into the liquid boundary 128 at the sample tip and subsequently delivered to the ESI source 114.

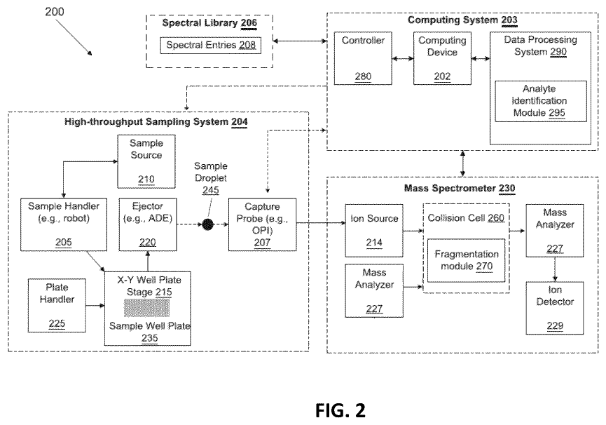

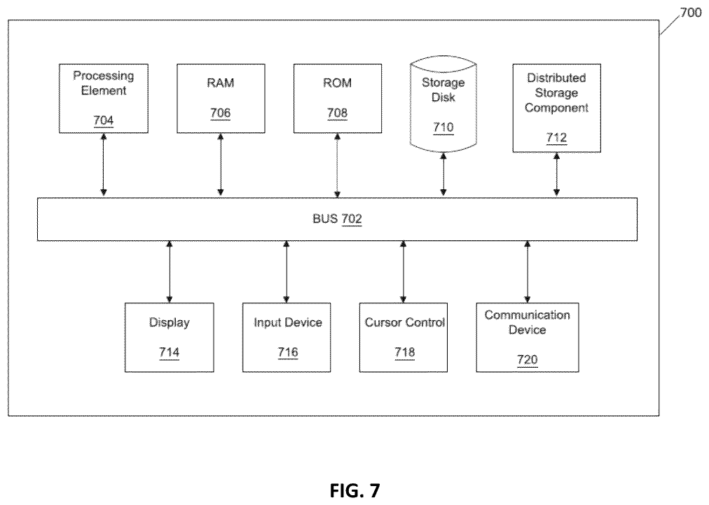

The system 100 includes an ADE 102 that is configured to generate acoustic ejection energy that is applied to a liquid contained within a reservoir 110 that causes one or more droplets or samples 108 to be ejected from the reservoir 110 into the open end of the sampling OPI 104. A controller 130 can be operatively coupled to and configured to operate any aspect of the system 100. This enables the acoustic transducer of the acoustic ejector 106 to inject droplets or samples 108 into the sampling OPI 104 as otherwise discussed herein substantially continuously, or for selected portions of an experimental protocol, by way of non-limiting example. Other types of sample introduction systems, such as gravity-based droplet systems may be utilized. ADE 102 and other non-contact ejection systems may be advantageous because of the high sample throughput that may be achieved. Controller 130 can be, but is not limited to, a microcontroller, a computer, a microprocessor, or any device capable of sending and receiving control signals and data, as described below with respect to the computing device illustrated in, e.g., FIG. 2 or FIG. 7. Wired or wireless connections between the controller 130 and the remaining elements of the system 100 are not depicted but would be apparent to a person of skill in the art.

As shown in FIG. 1, the ESI source 114 (when utilized) can include a source 136 of pressurized gas (e.g., nitrogen, air, or a noble gas) that supplies a high velocity nebulizing gas flow to the nebulizer nozzle 138 that surrounds the outlet tip of the electrospray electrode 116. As depicted, the electrospray electrode 116 protrudes from a distal end of the nebulizer nozzle 138. The pressured gas interacts with the liquid discharged from the electrospray electrode 116 to enhance the formation of the sample plume and the ion release within the plume for sampling by mass analyzer detector 120, e.g., via the interaction of the high-speed nebulizing flow and jet of liquid sample (e.g., analyte-solvent dilution). The liquid discharged may include liquid samples LS received from at least one reservoir 110 of the well plate 112. The liquid samples LS are diluted with the solvent S and typically separated from other samples by volumes of the solvent S (hence, as flow of the solvent S moves the liquid samples LS from the OPI 104 to the ESI source 114, the solvent S may also be referred to herein as a transport liquid). The nebulizer gas can be supplied at a variety of flow rates, for example, a flow rate in a range from about 0.1 L/min to about 40 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect/shock formation). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that may be disposed between the ionization chamber 118 and the mass analyzer detector 120 and configured to separate ions based on their mobility difference in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

FIG. 2 is a schematic diagram illustrating the operation of an example system combining acoustic droplet ejection (ADE) with an open port interface (OPI) sampling interface and electrospray ionization (ESI) source. In the illustrated example, the system 200 is operative to perform, e.g., high-throughput mass spectrometry analysis. Similar to the system 100 of FIG. 1, the system 200 includes a sampling system 204, a MS 230, a computing system 203, and optionally a spectral library 206 that may include a plurality of spectral entries 208.

In various aspects, the sampling system 204 may include at least one of a sample source 210 (similar to the reservoir 110 or well plate 112 of FIG. 1), a sample handler 205, a capture probe 207, an X-Y well plate stage 215, an ejector 220, and a plate handler 225. The sample source 210 and the sample handler 205 are operative to retrieve collections of samples from the sample source 210 and to deliver the retrieved collections to capture locations associated with sample capture probe 207. The system 200 may be operative to independently capture selected ones of the plurality of samples at the capture locations, e.g., capture probe 207, to optionally dilute the samples and to transfer the captured samples to MS 230 for mass analysis. In some embodiments, the sample source 210 may include a set of well plates in a storage housing and/or liquid for adding to well plates 235. The sample source 210 may include part of a liquid handling system that manipulates and/or injects liquid into the well plates 235. The sample handler 205 includes one or more electro-mechanical devices (e.g., robotics, conveyor belts, stages, and the like) that are capable of transferring samples (e.g., well plates) from the sample source 210 to other components of the sampling system 204 and/or to other components, such as the ejector 220 and/or the capture probe 207. As an example, the sample handler 205 may transfer a sample well plate 235 to the ejector 220 or the plate handler 225.

In various aspects, the ejector 220 is operable to eject droplets of samples 245 from the wells of the well plate 235. The size of the droplet or sample may typically be from 1 to 25 nanoliters. The ejector 220 may be any type of suitable ejector, such as an acoustic ejector, a pneumatic ejector, or another type of contactless ejector. In an example, the plate handler 225 receives a well plate 235 from the sample handler 205. The plate handler 225 transports the well plate 235 to a capture location that may be aligned with the capture probe 207. Once in the capture location, the ejector 220 ejects droplets 245 from one or more wells of the well plate 235. The plate handler 225 may include one or more electro-mechanical devices, such as a translation stage 215 that translates the well plate 235 in an X-Y plane to align wells of the well plate 235 with the ejector 220 and/or or the capture probe 207.

In various aspects, the MS 230 includes at least one of an ion source (e.g., ionization source) 214, a mass analyzer 227, an ion detector 229, and a collision cell 260. The MS 230 can be operative, for example, through use of ion source(s) or generator(s) 214 to produce sample ions of the sample introduced into the MS 230. The collision cell 260 is operative to fragment the precursor ions produced by the ion source 214 to generate product ions (fragment ions) derived from the precursor ions. In various examples, the mass analyzer 227 may be before the collision cell. The MS 230 is further operative to filter and detect selected ions of interest from the sample ions through the use of the mass analyzer 227 and ion detector 229. The mass analyzer 227 is operative to analyze the sample ions and produce a mass spectrometry dataset comprising all ion current signals from the sample ions.

In some aspects, the MS 230 is operative to perform tandem mass spectrometry analysis through the use of the collision cell 260. The collision cell 260 may further include a fragmentation module 270 operative to apply an energy to the selected precursor ions and cause the selected precursor ions to undergo fragmentation and generate product ions. The fragmentation module 270 may include at least one of collision induced dissociation (CID), surface induced dissociation (SID), electron capture dissociation (ECD), electron transfer dissociation (ETD), metastable-atom bombardment, photo-fragmentation, or combinations thereof.

It will also be appreciated by a person skilled in the art and in light of the teachings herein that the mass analyzer 227 can have a variety of configurations. Generally, the mass analyzer 227 is operative to process (e.g., filter, sort, dissociate, detect, etc.) sample ions generated by the ion source 214. By way of non-limiting example, the mass analyzer 227 may be a triple quadrupole mass spectrometer, or any other mass analyzer known in the art and modified in accordance with the teachings herein.

In various aspects, the computing system 203 may include a computing device 202 as described above, a controller 280, and a data processing system 290. The controller 280 may be in the form of electronic signal processors and in electrical communication with other subsystems within the system 200. The controller 280 may be operative to coordinate some or all of the operations of the pluralities of the various components of the system 200. In one example, the controller 280 may be a controller for the mass spectrometer 227 and may be used as the primary controller for controlling components in addition to those components housed within the mass spectrometer 227. As such, the controller 280 may be considered the main or central controller that orchestrates, or communicates with, the other controllers to carry out the operations discussed herein in a more efficient manner.

In various aspects, the data processing system 290 may include various components and modules operative to process mass spectrometry data and to provide real-time feedback to users and other subsystems. In some embodiments, the data processing system 290 further includes an analyte identification module 295. The analyte identification module 295 may be operative to perform a library search and predict compound identity of a target analyte in a test sample, optionally through use of the trained machine learning algorithm. In various examples, the computing system 203 may be similar to the computing device 700 described in greater detail below with respect to FIG. 7.

In operation, the sampling system 204 (including sample source 210 and sample handler 205) can iteratively deliver independent samples from a plurality of sample sources (e.g., a droplet from a well of well plate 235) to the capture probe 207. The capture probe 207 can dilute and transport each such delivered sample to the MS 230 disposed downstream of the capture probe 207 for ionizing the diluted sample. The mass analyzer 227 can receive generated ions from the ion source 214 and/or the collision cell 260 for mass analysis. The mass analyzer 227 is operative to selectively separate ions of interest from generated ions received from the ion source 214 and to deliver the ions of interest to the ion detector 229 that generates a mass spectrometer signal indicative of detected ions to the computing system 203. In some aspects, the separate ions of interest may be indicated in an analysis instruction associated with that sample. In some aspects, the separate ions of interest may be indicated in an analysis instruction identified by an indicia physically associated with the plurality of samples.

The system 200 may include a commercial product such as, e.g., a Biomek computer available from Beckman Coulter Life Sciences, which is in operative communication with a MS 230 and a controller for the capture probe 207, which may include, for example, a SCIEX OS or Analyst® computer available from SCIEX. The Analyst® or SCIEX OS computer includes a control controller for the capture probe 207, represented for example by SCIEX open port interface software, and a controller for the MS 230, which may be the Analyst® computer. The MS 230 and the controller for capture probe 207 may be further in operative communication with an ejector 220 and an X-Y well plate stage 215, which may be, for example, a liquid droplet ejector with embedded computer or processor. For the purposes of this disclosure, these distributed controller components may collectively be considered to be a system controller, and depending upon the configuration, may be centralized or distributed as is the case here. For instance, one of the controllers or controller components may send signals to the other controllers to control the respective devices.

In one particular example, the high-throughput system 200 employs the ADE-OPI-MS technology. The ADE-OPI-MS system according to the present disclosure relies on acoustic dispensing of droplets directly from the wells of the plate or sample source under analysis. The acoustically dispensed droplets, which are typically at nanoliter scale, with precise control and independent of the sample solvent, are acoustically ejected from the ejected sample and introduced to a vortex at the opening of the OPI and delivered directly to the ionization source of the MS for detection. The substantially small samples required, coupled with the method's resilience in handling unpurified samples, make this technology advantageous for direct sampling from the well plate or sample source. The ADE-OPI-MS system and method also offer significant speed advantages: with an average analysis time of 1-2 seconds per sample and a small quantity of 1-10 nanoliter per sample, such that a typical well plate containing 384 wells can be analyzed in under 15 min. Thus, the ADE-OPI-MS system advantageously enables high-throughput analysis of a large quantity of samples and generate a large volume of data within a meaning time frame such as a day. In addition, the ADE-OPI is compatible with both nominal and high-resolution mass spectrometers, allowing rapid quantification with the former, and extensive analyte identification with the latter. It should be noted that although the MS 230 is discussed herein, principles of the above embodiments may be applicable to any other mass analyzing device, or to any sample detection device.

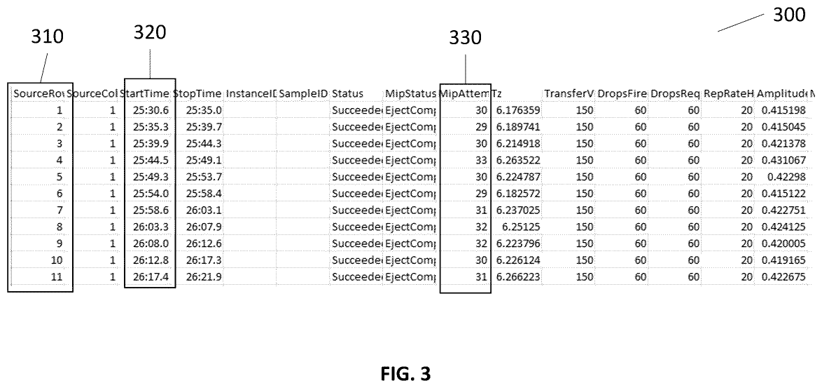

FIG. 3 depicts an example acoustic ejection log, according to various examples of the disclosure. In FIG. 3, the acoustic ejection log 300 includes a record of the acoustic ejection energy for previous sample ejections. For example, the previous sample ejections may be previous ejections from each well or sample source of a well plate or reservoir. For example, the sample source may be similar to the well plate 112 discussed above with respect to FIG. 1. In various examples, the acoustic ejection log 300 includes, e.g., a listing 310 of the various ejections, the start time 320 of each acoustic ejection, and parameters 330 that correlate to the acoustic ejection energies for each received sample that has been ejected. Accordingly, by examining the acoustic ejection log 300, it may be possible to determine which of the parameters 330 that correlate to acoustic ejection energies may be invalid. For example, a parameter 330 that correlates to the acoustic ejection energy may be invalid if a value thereof is outside of a predetermined range of acoustic ejection energies, or if the value thereof is below a predetermined threshold of acoustic ejection energies. In the illustration of FIG. 3, it appears that all the parameters 330 that correlate to acoustic ejection energies are within a relatively close range of 29 to 33. Accordingly, it may be possible to conclude based on FIG. 3 that the parameters 330 that correlate to acoustic ejection energies in this case are valid.

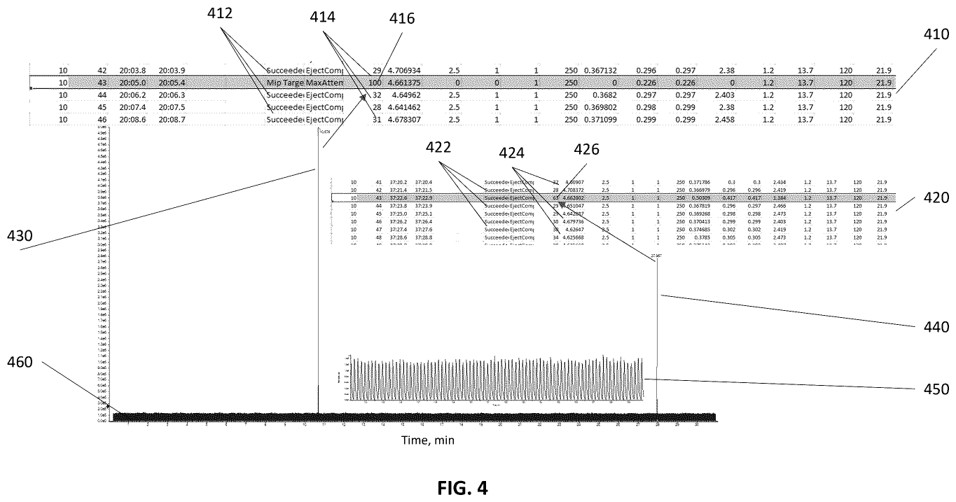

FIG. 4 depicts an example of determining an abnormal signal based on the acoustic ejection log, according to various examples of the disclosure. In FIG. 4, the acoustic ejection logs 410 and 420 display a list of sequential sample ejection events 412 and 422, respectively. For example, with respect to acoustic ejection log 410, the sample ejection events 412 include sample ejection events for which the acoustic ejection energies 414 are sufficiently close together to fall within a range for samples 42 and 44-46. For these samples, the acoustic ejection energies are in a range of 28-32. In an example, the sample ejection events 412 also include an acoustic ejection energy 416, corresponding to sample 43, that is substantially higher than the other acoustic ejection energies 414. In the example illustrated in FIG. 4, the acoustic ejection energy 416 of sample 43 has an intensity of 100 while the acoustic ejection energies 414 of the other samples, e.g., samples 42 and 44-46, have intensities in the range of 28-32.

Accordingly, it may be concluded, based on this difference between the acoustic ejection energies of sample 43 and of samples 42 and 44-46, that the sample ejection event 412 that corresponds to the acoustic ejection energy 416 and sample 43 may be abnormal. For example, sample 43 may be damaged, corrupted, or otherwise compromised so as to render the acoustic ejection energy invalid in analyzing sample 43. In various examples, the acoustic ejection energy 416 is described in the acoustic ejection log 410 as a number representative of the acoustic ejection energy. In an actual acoustic ejection energy measurement such as a MS readout with respect to time 460, which is the signal obtained from the mass analyzer, the acoustic ejection energy 416 is derived from a peak such as peak 430. In FIG. 4, the acoustic MS readout with respect to time 450 may be an enlarged portion of the MS readout with respect to time 460. In various examples, upon determining that the measurement of sample 43 is invalid, another measurement of the same sample may be performed. For example, another measurement of a sample from the same sample source as sample 43 may be performed after, e.g., modifying one or more parameters of the sample source or of the sample analyzing system.

In various examples, FIG. 4 also includes another acoustic ejection log 420 describing various sample ejection events. For example, the sample ejection events 422 include events corresponding to samples 41, 42 and 44-48, for which the acoustic ejection energies 424 are sufficiently close together to fall within a range of 28 to 34. The sample ejection events 422 also include an acoustic ejection energy 426, corresponding to sample 43, that is substantially higher than the other acoustic ejection energies 424. In the example illustrated in FIG. 4, the acoustic ejection energy 426 of sample 43 has an intensity of 63 while the acoustic ejection energies 424 of the other samples, e.g., samples 41, 42, and 44-48, have intensities in the range of 28 to 34.

Accordingly, it may be concluded based on this difference that the acoustic ejection energy 426 that corresponds to the sample ejection event 422 and sample 43 may be abnormal. For example, sample 43 may be damaged, corrupted, or otherwise compromised so as to render the acoustic ejection energy for that invalid in analyzing sample 43. However, because the difference between the acoustic ejection energies of sample 43 and samples 41, 42, and 44-48 is not as substantial as in the acoustic ejection log 410 discussed above, it may be possible that acoustic ejection energy 426 may be a valid signal. In various examples, the acoustic ejection energy 426 is described in the acoustic ejection energy measurement such as MS readout with respect to time 460, the acoustic ejection energy 426 is derived from a peak such as peak 440. In various examples, upon determining that the measurement of sample 43 is invalid, another measurement of the same sample may be performed. For example, another measurement of a sample from the same sample source as sample 43 may be performed after, e.g., modifying one or more parameters of the sample source or of the sample analyzing system.

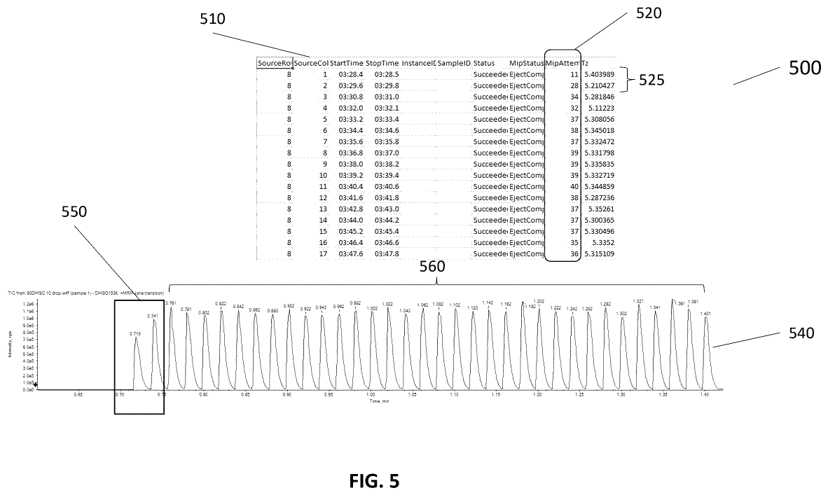

FIG. 5 depicts an example of determining an abnormal signal based on a received MS signal, according to various examples of the disclosure. Unlike in FIG. 4, the determination in FIG. 5 of whether a measured signal is valid or invalid is based on an examination of the measured MS signal instead of the acoustic ejection energy. In FIG. 5, the table 500 includes a description of the various measurements that have been performed, also represented by the spectrum 540. For example, the samples 510 are displayed next to, e.g., parameters 520 that correlate to the acoustic ejection energies. In various examples, although the table 500 includes parameters 520 that correlate to the acoustic ejection energies representative of the various MS measurement results, the parameters 520 are derived from the actual measurement spectrum 540.

In various examples, based on a visual examination of the measurement spectrum 540, it is possible to determine that the measurement spectrum 540 includes two peaks 550 that have intensities that are noticeably lower than the remaining peaks 560. With respect to the table 500, by examining the parameters 520 that correlate to the acoustic ejection energies, it is also possible to determine that two of the intensities, labeled 525, which correspond to samples 1 and 2 and to the first two peaks 550, have values of 11 and 28, respectively, while the remaining parameters 520, which that correlate to the acoustic ejection energies and correspond to the remaining peaks 560, are in the range of 32-40. Accordingly, it may be possible to determine that samples 1 and 2, for which the measured signal intensities 525 are outside of the range of the remaining samples, may be invalid by being damaged, corrupted, or otherwise compromised. In various examples, upon determining that the measurement of samples 1 and 2 are invalid, another measurement of the same samples may be performed. For example, another measurement of samples that are from the same sample sources as samples 1 and 2 may be performed after, e.g., not making any changes to sample sources or the sample analyzing system, or modifying one or more parameters of the sample sources or of the sample analyzing system.

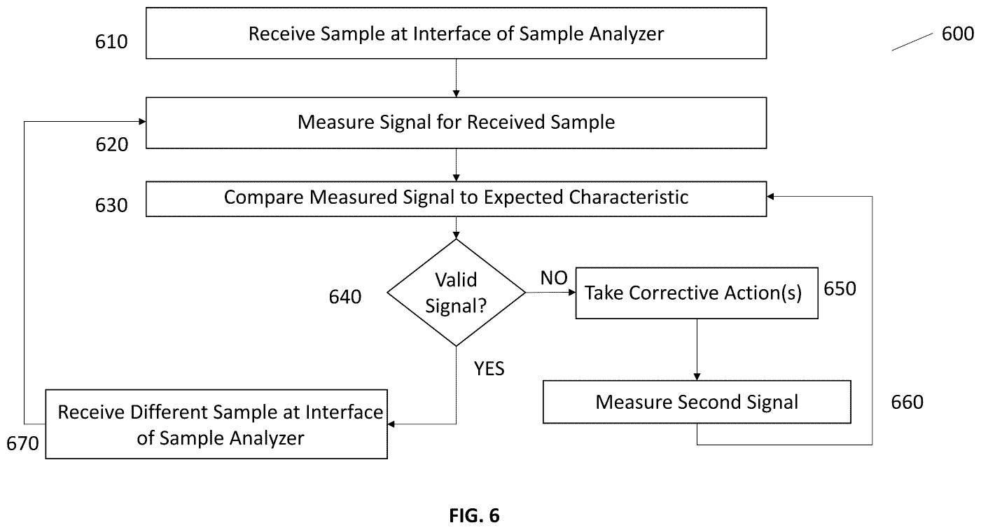

FIG. 6 is a flow chart depicting an example method 600 for sample re-runs, in accordance with various examples of the disclosure. For the sole purpose of convenience, method 600 is described through use of the example systems 100 or 200 described above. However, it is appreciated that the method 600 may be performed by any suitable system such as, e.g., MALDI, or other analysis techniques using a pneumatic nebulizer as a sample provider.

In various examples, operation 610 includes receiving a droplet at an interface of a sample analyzing system. As an example, the sample, referred to herein as a first sample, may be a portion of a larger sample source and may be, e.g., one or more droplets, or one or more sample portions. As yet another example, the sample may be received at an interface such as, e.g., the OPI 104 discussed above with respect to FIG. 1. In other examples, the sample analyzing system may be or include a mass spectrometer such as mass spectrometer 227 discussed above, or an ion detector such as ion detector 229 discussed above, in a mass analysis system such as, e.g., the AEMS 100 discussed above. For example, during operation 610, the first sample may be ejected from a reservoir such as, e.g., reservoir 110 discussed above with respect to FIG. 1, and an ejection energy of the first sample may be an acoustic ejection energy. For example, the acoustic ejection energy is obtained from an acoustic ejection energy log. In another example such as the AEMS 100 discussed above, the first sample may be contained in a well, the well being one of a number of wells in a well plate such as well plate 112 discussed above with respect to FIG. 1. Also, the first sample being received during operation 610 may be a portion of a larger sample source that is contained in the same well or reservoir. In other examples, the sample analyzing system may receive the first sample a matrix-assisted laser desorption interface or at a pneumatic nebulizer interface.

During operation 620, the method 600 includes measuring a signal for the received first sample, the signal being referred to herein as a measured first signal. For example, the measured first signal may be one or more signal peaks in a sample trace generated by a mass analysis system such as, e.g., the AEMS 100 discussed above. In other examples, the measured first signal may be expressed as a measured signal intensity that may be represented as one or more peaks detected over a period of time. The measured signal may also be a height of the signal peak, an area under the signal peak, and/or a full-width-half maximum of the signal peak or other mass spectra information. Measuring a signal may also include determining an acoustic ejection energy of the received first sample.

During operation 630, the measured first signal may be compared to an expected characteristic of the sample analyzing system. For example, the characteristic of the sample analyzing system may be a signal intensity threshold such as, e.g., a predetermined signal intensity threshold, under which the first signal may be deemed to be invalid because such a signal may be indicative of a corrupted sample or an erroneous or incomplete ejection. In other examples, the predetermined signal intensity threshold may be a threshold above which the first signal may be deemed to be indicative of a corrupted sample or erroneous ejection. In yet another example, the characteristic may be a predetermined signal intensity range outside of which the first signal may be deemed to be indicative of a corrupted sample or erroneous or incomplete ejection. In another example, the characteristic may be a range of signal intensities that encompasses a majority of signals of other samples previously measured, and when the measured signal intensity of a given sample is outside of that range, the signal may be deemed to be indicative of a corrupted sample or erroneous or incomplete ejection. In an example, the predetermined signal intensity range is between 10% and 20% of the measured first signal.

During operation 640, the method 600 determines whether the measured first signal is valid. For example, the measured first signal is valid if it is below a predetermined threshold, or if it is within a predetermined range of signal intensities, as discussed above. In other examples, the measured first signal may be determined not to be valid if the measured first signal is outside of the predetermined range.

According to various examples, if the measured first signal is determined not to be valid during operation 640, then during operation 650, one or more corrective actions may be taken. For example, a corrective action may be or include modifying one or more parameters of, e.g., the sample analyzing system, or one or more parameters of the sample source. Corrective actions may also include correcting the measurement in an acoustic ejector, an ionization chamber, and/or a mass spectrometer. For example, parameters of the sample analyzing system may include an ejection energy, a signal background, and the like. Parameters of the sample source may include a volume of the ejected first sample, a viscosity of the ejected first sample, and the like. In other examples, taking a corrective action during operation 650 may also include merely repeating the measurement without changing any parameter of the parameters discussed above, or correcting the measurement in any manner.

In various examples, after the one or more corrective actions have been taken during operation 650, another signal, referred to herein as second signal, is measured for a second sample during operation 660. For example, the second sample which signal is to be measured is from the same sample source as the first sample received during operation 610. Accordingly, after the corrective actions have been performed on the sample source contained in, e.g., a well of the well plate of an acoustic ejector, or in a reservoir holding the sample source, the second sample from the same sample source as the first sample is ejected, and a second signal is measured during operation 660. In an example, taking the corrective actions and/or measuring the second signal is performed automatically when the measured first signal is determined not to be valid. In various examples, when the second signal is measured during operation 660, the method 600 returns to operation 630, where that second signal is compared to the expected characteristics of the analysis system, as discussed above with respect to operation 630. In other examples, taking the corrective actions and/or measuring the second signal may be performed at any desired time during the measurement process of the sample sources. For example, taking the corrective actions and/or measuring the second signal may be performed at the end of measurement of all the sample sources being measured, or at any point before the end of the measurement of all the sample sources being measured.

According to various examples, when the measured first signal is determined to be valid during operation 640, then during operation 670, a sample from a different sample source such as, e.g., a different well, may be ejected and received by the interface of the sample analyzing system. When the different sample is received at the interface of the sample analyzing system, the method 600 returns to operation 620, where a signal for the received sample from the different sample source, received during operation 670, may be measured. Accordingly, in various examples, the method 600 allows for the measurement of various samples in, e.g., a well plate or other large- sized sample provider, and provide the possibility of re-measuring any one of the samples that exhibited an anomaly by generating an invalid signal at the sample analyzing system.

FIG. 7 depicts a block diagram of a computing device similar to the computing device 202 discussed above with respect to FIG. 2. In the illustrated example, the computing device 700 may include a bus 702 or other communication mechanism of similar function for communicating information, and at least one processing element 704 (collectively referred to as processing element 704) coupled with bus 702 for processing information. As will be appreciated by those skilled in the art, the processing element 704 may include a plurality of processing elements or cores, which may be packaged as a single processor or in a distributed arrangement. Furthermore, a plurality of virtual processing elements 704 may be included in the computing device 700 to provide the control or management operations for, e.g., the mass analysis systems 100 and 200 illustrated above.

The computing device 700 may also include one or more volatile memory(ies) 706, which can for example include random access memory(ies) (RAM) or other dynamic memory component(s), coupled to one or more busses 702 for use by the at least one processing element 704. Computing device 700 may further include static, non-volatile memory(ies) 708, such as read only memory (ROM) or other static memory components, coupled to busses 702 for storing information and instructions for use by the at least one processing element 704. A storage component 710, such as a storage disk or storage memory, may be provided for storing information and instructions for use by the at least one processing element 704. As will be appreciated, the computing device 700 may include a distributed storage component 712, such as a networked disk or other storage resource available to the computing device 700.

The computing device 700 may be coupled to one or more displays 714 for displaying information to a user. Optional user input device(s) 716, such as a keyboard and/or touchscreen, may be coupled to Bus 702 for communicating information and command selections to the at least one processing element 704. An optional cursor control or graphical input device 718, such as a mouse, a trackball or cursor direction keys for communicating graphical user interface information and command selections to the at least one processing element. The computing device 700 may further include an input/output (I/O) component, such as a serial connection, digital connection, network connection, or other input/output component for allowing intercommunication with other computing components and the various components of, e.g., the mass analysis systems 100 and 200 discussed above.

In various embodiments, computing device 700 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of, e.g., the mass analysis systems 100 and 200 may be supported by operation of the distributed computing systems.

The computing device 202 discussed above with respect to FIG. 2, similar to the computing device 700, may be operative to control operation of the components of the mass analysis system 200 and the sampling system 204 through a communication device such as, e.g., communication device 720, and to handle data generated by components of the mass analysis system 200 through the data processing system 200. In some examples, analysis results are provided by the computing device 700 in response to the at least one processing element 704 executing instructions contained in memory 706 or 708 and performing operations on data received from the mass analysis system 200. Execution of instructions contained in memory 706 and/or 708 by the at least one processing element 704 can render, e.g., the mass analysis systems 100 and 200 and associated sample delivery components operative to perform methods described herein.

The term “computer-readable medium” as used herein refers to any media that participates in providing instructions to the processing element 704 for execution. Such a medium may take many forms, including but not limited to, non-volatile media, volatile media, and transmission media. Non-volatile media includes, for example, optical or magnetic disks, such as disk storage 710. Volatile media includes dynamic memory, such as memory 706. Transmission media includes coaxial cables, copper wire, and fiber optics, including the wires that include bus 702.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 704 for execution. For example, the instructions may initially be carried on the magnetic disk of a remote computer. The remote computer can load the instructions into its dynamic memory and send the instructions over a telephone line using a modem. A modem local to computing device 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which the processing element 704 retrieves and executes the instructions. The instructions received by memory 706 and/or memory 708 may optionally be stored on storage device 710 either before or after execution by the processing element 704.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of correcting a measurement in a sample analyzing system, the method comprising:
receiving a first sample at an interface of the sample analyzing system, the first sample being a portion of a sample source;
measuring a first signal for the received first sample to generate a measured first signal;
comparing the measured first signal to an expected characteristic of the sample analyzing system to determine whether the measured first signal is not valid; and
when the measured first signal is determined not to be valid:
one of taking no corrective action and taking one or more corrective actions on one of the sample analyzer and the sample source;
receiving a second sample at the sampling interface, the second sample being another portion of the sample source; and
measuring a second signal for the received second sample to generate a measured second signal.

2. (canceled)

3. The method of claim 1, wherein receiving the first sample at the interface of the sample analyzing system comprises receiving the first sample at a sampling open port interface.

4. The method of claim 1, wherein receiving the first sample at the interface of the sample analyzing system comprises receiving the first sample at one of a matrix-assisted laser desorption interface and a pneumatic nebulizer interface.

5. The method of claim 1, wherein measuring the first signal for the received first sample comprises measuring a signal indicative of a number of detected ions per second.

6. The method of claim 1, wherein measuring the first signal for the received first sample comprises measuring a signal peak corresponding to the received first sample by measuring at least one of a height of the signal peak, an area under the signal peak, and a full-width-half maximum of the signal peak, and wherein measuring the first signal for the received first sample further comprises determining an acoustic ejection energy of the received first sample.

7. (canceled)

8. (canceled)

9. The method of claim 8, wherein comparing the measured first signal to the expected characteristic of the sample analyzing system comprises:
comparing the measured first signal to at least one of a predetermined signal intensity threshold, a predetermined signal intensity range, and a predetermined mass; and
comparing the determined acoustic ejection energy to a predetermined acoustic ejection energy threshold,
and wherein the measured first signal is determined to be invalid when at least one of:
the measured first signal is under the predetermined signal intensity threshold;
the measured first signal is outside of the predetermined signal intensity range; and
an acoustic ejection energy of the first sample is below the predetermined acoustic ejection energy threshold.

10. (canceled)

11. (canceled)

12. The method of claim 1, wherein taking the one or more corrective actions comprises modifying an operating parameter of at least one of the sample source and the sample analyzing system by modifying at least one of:
a volume of the second sample;
a viscosity of the second sample; and
an acoustic ejection energy for ejecting the second sample.

13. (canceled)

14. The method of claim 1, wherein receiving the first sample at the sampling interface comprises:
ejecting the first sample from a well plate, the well plate comprising a plurality of wells, the sample source being contained in one of the plurality of wells;
wherein an ejection energy of the first sample comprises an acoustic ejection energy.

15. (canceled)

16. The method of claim 1, wherein measuring the second signal comprises automatically measuring the second signal when the measured first signal is determined not to be valid.

17. A sample analyzing system comprising:
a sample receiver;
a mass analysis device fluidically coupled to the sample receiver;
a processor operatively coupled to the sample receiver and to the mass analysis device; and
a memory coupled to the processor, the memory storing instructions that, when executed by the processor, perform a set of operations comprising:
receiving a first sample at an interface of the sample receiver, the first sample being a portion of a sample source;
measuring, at the mass analysis device, a first signal for the received first sample to generate a measured first signal;
comparing the measured first signal to an expected characteristic of the sample analyzing system to determine whether the measured first signal is not valid; and
when the measured first signal is determined not to be valid:
one of taking no corrective action and taking one or more corrective actions on one of the sample analyzer and the sample source;
receiving, at the interface of the sample receiver, a second sample, the second sample being another portion of the sample source; and
measuring, at the mass analysis device, a second signal for the received second sample to generate a measured second signal.

18. (canceled)

19. The sample analyzing system of claim 17, wherein the sample receiver comprises an open port interface.

20. (canceled)

21. The sample analyzing system of claim 20, further comprising a non-contact sample ejector; wherein the set of operations comprises:
receiving the first sample by introducing, with the non-contact sample ejector, the first sample from the well plate into the sample receiver.

22. The sample analyzing system of claim 21, wherein the non-contact sample ejector comprises an acoustic droplet ejector.

23. The sample analyzing system of claim 17, comprising at least one of:
a matrix-assisted laser desorption interface; and
a pneumatic nebulizer interface.

24. The sample analyzing system of claim 17, wherein the first signal comprises a signal peak corresponding to the received first sample made up of at least one of a height of the signal peak, an area under the signal peak, and a full-width-half maximum of the signal peak.

25. (canceled)

26. The sample analyzing system of claim 17, wherein the first signal comprises an acoustic ejection energy of the received first sample, and wherein the set of operations comprises comparing the measured first signal to the expected characteristic of the sample analyzing system by:
comparing the measured first signal to at least one of a predetermined signal intensity threshold, a predetermined signal intensity range, and a predetermined mass;
comparing the acoustic energy of the received first sample to a predetermined acoustic ejection energy threshold; and
determining that the signal is invalid when at least one of:
the signal is below the predetermined signal intensity threshold;
the signal is outside of the predetermined signal intensity range; and
the acoustic ejection energy of the first sample is below the predetermined acoustic ejection energy threshold.

27. (canceled)

28. (canceled)

29. (canceled)

30. The sample analyzing system of claim 17, wherein the set of operations comprises measuring the second signal by automatically measuring the second signal when the first signal is determined to be invalid.

31. The sample analyzing system of claim 17, further comprising an ionization element, wherein the set of operations further comprises ionizing the received first sample and the received second sample by the ionization element towards the mass analysis device.

32. The sample analyzing system of claim 17, wherein the mass analysis device comprises at least one of a differential mobility spectrometer (DMS), a mass spectrometer (MS), and a DMS/MS.

33. (canceled)

34. (canceled)
